(19) United States
(12) Patent Application Publication
(10) Pub. No.: US 2005/0208350 A1
(43) Pub. Date: Sep. 22, 2005

(54) Reformed gas fuel cell system

(75) Inventors: Yoshiyuki Isozaki, Tokyo (JP); Yuusuke Sato, Tokyo (JP); Hideo Kitamura, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 10/997,921

(22) Filed: Nov. 29, 2004

(30) Foreign Application Priority Data
Nov. 28, 2003 (JP) P2003-400112

(51) Int. Cl. H01M 8/06; C01B 3/38; B01J 8/04

(52) U.S. Cl. 429/19; 422/188

(57) ABSTRACT

A fuel cell system including a fuel supplying unit configured to supply a fuel containing dimethyl ether; a reforming portion including a conduit through which the fuel can be passed; a first catalyst provided on a surface within the conduit and configured to accelerate a reforming reaction by which the fuel is reformed to a gas containing hydrogen; a second catalyst provided on a surface within the conduit and configured to accelerate a shift reaction by which carbon monoxide and water produced during the reforming reaction are converted to hydrogen and carbon dioxide; a CO removing portion configured to remove carbon monoxide left unreacted after the shift reaction; and a fuel cell unit configured to generate electricity from oxygen and the hydrogen produced by the reforming reaction and shift reaction.

### CROSS REFERENCE TO RELATED APPLICATIONS

This application is based upon and claims the benefit of priority from prior Japanese Patent Application P2003-400112 filed on Nov. 28, 2003; the entire contents of which are incorporated by reference herein.

### BACKGROUND OF THE INVENTION

1. Field of the Invention

The present invention relates to a fuel cell adapted to use a reformed gas containing hydrogen obtained by the steam reforming of a fuel.

2. Description of the Background

In recent years, a fuel cell has attracted attention as a clean electric supply which prevents emission of harmful materials such as sulfur oxide and nitrogen oxide. A fuel cell system typically generates electricity by allowing reformed gas which contains hydrogen into an anode and allowing air into a cathode. The reformed gas is obtained by reforming a fuel such as natural gas, naphtha, alcohols, and ether with a reformer including a reforming catalyst inside.

The reformed gas typically contains some by-products. For instance, the reformed gas obtained by the steam reforming of dimethyl ether contains carbon dioxide and about 1% to 2% of carbon monoxide as by-products besides hydrogen. Carbon monoxide deteriorates the anode catalyst of the fuel cell unit, causing the deterioration of the electricity-generating capacity of the fuel cell unit. Thus, a fuel cell has been proposed which uses a CO shift portion and a CO removing portion to reduce the concentration of carbon monoxide in the reformed gas (see, e.g., JP-A-2002-289245(KOKAI), FIG. 1).

However, the above fuel cell is provided to a large-sized, long-operating system. When such a fuel cell is used in a frequent ON-OFF system, such as an electronic apparatus, the reforming catalyst undergoes oxidation and deterioration by oxygen which has penetrated the reforming portion during suspension of operation. Thus, incidental facilities for replacing the gas which has penetrated the reforming portion are under consideration. However, such incidental facilities typically prevent the reduction of the size of the fuel cell.

### SUMMARY OF THE INVENTION

According to an exemplary embodiment, the present invention provides a fuel cell system including: a fuel supplying unit configured to supply a fuel containing at least dimethyl ether; a reforming portion including a conduit provided through which the fuel supplied by the fuel supplying unit can be passed; a first catalyst provided on a first surface within the conduit and configured to accelerate a reforming reaction by which the fuel is reformed to a gas containing hydrogen, the first catalyst including a solid acid and a first noble metal; a second catalyst provided on the first surface or a second surface within the conduit and configured to accelerate a shift reaction by which carbon monoxide and water produced during the reforming reaction are converted to hydrogen and carbon dioxide, the second catalyst including a solid base and second noble metal; a CO removing portion configured to remove carbon monoxide left unreacted after the shift reaction; and a fuel cell unit configured to generate electricity from oxygen and the hydrogen produced by the reforming reaction and shift reaction.

It is to be understood that the foregoing general discussion and the following description of the embodiments of the invention are both exemplary, i.e., are not restrictive of the invention.

### BRIEF DESCRIPTION OF THE DRAWINGS

The invention is best understood from the following description of the non-limiting embodiments when read in connection with the accompanying drawings, wherein:

FIG. 1 is a diagram illustrating a fuel cell system according to a first embodiment of the invention;

FIG. 2 is a graph illustrating temperature characteristics of CO shift catalysts in the fuel cell system according to the first embodiment of the invention;

FIG. 3 is a diagram illustrating a part of the fuel cell system according to the first embodiment of the invention;

FIG. 4 is a partial diagram illustrating a first modification of the fuel cell system according to the first embodiment of the invention;

FIG. 5 is a partial diagram illustrating a second modification of the fuel cell system according to the first embodiment of the invention;

FIG. 6 is a diagram illustrating a fuel cell system according to a second embodiment of the invention;

FIG. 7 is a graph illustrating temperature characteristics of CO selective methanation catalyst in the fuel cell system according to the second embodiment of the invention;

FIG. 8 is a diagram illustrating a fuel cell system according to a third embodiment of the invention; and

FIG. 9 is a graph illustrating temperature characteristics of CO equilibrium conversion of CO shift catalysts in the fuel cell system according to the third embodiment of the invention.

### DETAILED DESCRIPTION OF THE INVENTION

Referring now to the drawings in which like reference numerals designate identical or corresponding parts throughout the several views.

### First Embodiment

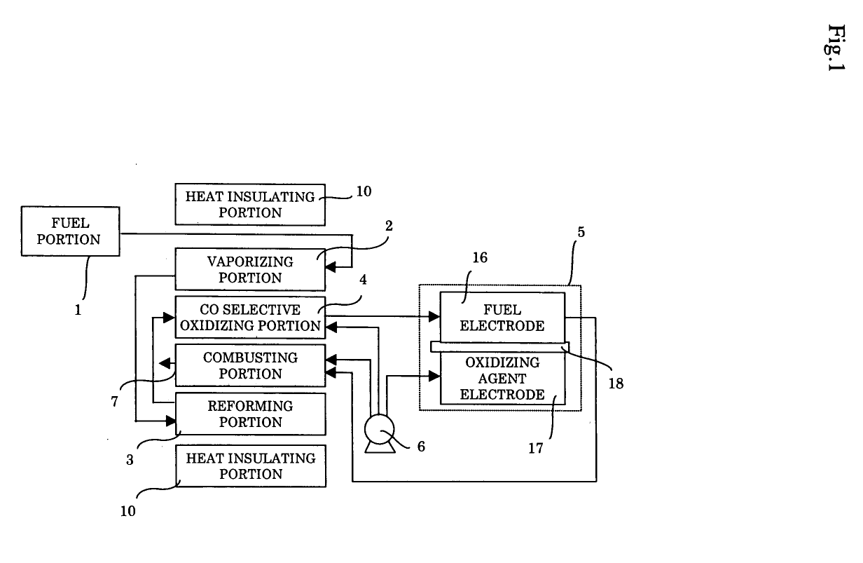

FIG. 1 illustrates an example of a first non-limiting embodiment of a fuel cell according to the invention.

A fuel portion 1 has a mixture of ether and water or a mixture of ether, water and alcohol stored as a fuel for the fuel cell. Examples of alcohols that may be employed include methanol and ethanol. In particular, the use of methanol may better enhance the mutual solubility of dimethyl ether.

A vaporizing portion 2 is connected to the fuel portion 1. The fuel which has been passed to the vaporizing portion 2 is vaporized, e.g., vaporized by heat.

A reforming portion 3 is connected to the vaporizing portion 2. The vaporized fuel which has been passed to the reforming portion 3 is reformed to a gas containing hydrogen, e.g., from 50 mol % to 75 mol % (reformed gas). Inside the reforming portion 3 is provided a channel or other conduit through which the vaporized gas is passed. On a surface within the channel, e.g., an inner wall surface or other surface contacting the vaporized fuel, is provided a catalyst for accelerating the reforming of the vaporized gas to the reformed gas.

A CO selective oxidizing portion 4 (CO removing portion) is connected to the reforming portion 3. The gas which has been reformed in the reforming portion 3 and passed to the CO selective oxidizing portion 4 contains carbon dioxide or carbon monoxide as a by-product besides hydrogen. Carbon monoxide deteriorates the anode catalyst of a fuel cell unit, causing the deterioration of electricity-generating properties of the fuel cell unit. Therefore, carbon monoxide is oxidized with supplied oxygen, e.g., supplied from the atmosphere or other reserve by an air pump 6, to carbon dioxide at the CO selective oxidizing portion 4. Accordingly, the carbon monoxide may be removed to a concentration of less than 10 ppm before the gas containing hydrogen is supplied from the reforming portion 3 into a fuel cell stack 5.

The fuel cell stack 5 is connected to the CO selective oxidizing portion 4. The reformed gas, from which carbon monoxide has been removed, is passed to the fuel cell stack 5. In the fuel cell stack 5, the hydrogen in the reformed gas reacts with the supplied oxygen. With this reaction, the fuel cell 5 produces water and generates electricity.

A combusting portion 7 is connected to the fuel cell stack 5. In the fuel cell stack 5, the hydrogen reacts with oxygen to produce water. However, the waste gas from the fuel cell stack 5 contains unreacted hydrogen. In the combusting portion 7, the unreacted hydrogen combusts with oxygen, e.g., oxygen supplied by the air pump 6, to generate heat. During this procedure, the combustion heat can be utilized to heat components of the fuel cell, e.g., the vaporizing portion 2, the reforming portion 3, the CO selective oxidizing portion 4. The vaporizing portion 2 can be heated by combustion heat, e.g., from 100° C., to 150° C.

In order to raise the heating efficiency, uniformalize the temperature and protect parts having a low heat resistance, such as a peripheral electronic circuit, the vaporizing portion 2, the reforming portion 3, the CO selective oxidizing portion 4 and the combusting portion 7 may be insulated. For instance, a periphery of those components may be covered by a heat insulating portion 10.

The reforming portion 3 will be further described hereinafter. Inside the reforming portion 3 is provided a channel, e.g., serpentine or parallel channel, through which the vaporized fuel flows. On a surface within the channel are provided a first catalyst (reforming catalyst), e.g., made of a solid acid having a first noble metal supported thereon and a second catalyst (CO shift catalyst), e.g., made of a solid base having a second noble metal supported thereon.

An exemplary reforming reaction and reforming catalyst will be further described hereinafter. Ether, e.g., dimethyl ether, is subjected to steam reforming, e.g., according to a first step reaction represented by the following formula (1), to produce an alcohol, e.g., methanol. Subsequently, the alcohol is subjected to steam reforming, e.g., according to a second step reaction represented by the following formula (2), to produce hydrogen and carbon dioxide.
CH₃OCH₃+H₂O→2CH₃OH (1)
CH₃OH+H₂O→CO₂+3H₂ (2)

A solid acid, e.g., γ-alumina (γ-Al₂O₃), may be used to catalyze the first step reaction. A noble metal catalyst, e.g., platinum (Pt), palladium (Pd) and rhodium (Rh), may be used to catalyze the second step reaction. If the supported amount of the first noble metal falls below 0.25% by weight of this exemplary catalyst, the steam reforming rate of methanol decreases. On the contrary, if the supported amount of the first noble metal exceeds 1.0% by weight of the catalyst, the steam reforming rate of methanol plateaus.

As a reforming catalyst, γ-alumina having 0.25% by weight of platinum supported thereon was further examined and will be described by way of a non-limiting example. More particularly, this catalyst was examined in an experiment of the steam reforming of dimethyl ether.

In the experiment, the molar ratio of dimethyl ether (DME) to water in the mixture of dimethyl ether and water was 1:4, the amount of the catalyst was 1 g and the contact time (W/F) was about 3 g−cat·hr/mol. The reaction temperature was measured by a temperature sensor disposed in the vicinity of the catalyst supported on the inner wall surface within the channel in the reforming portion 3.

The percent conversion of dimethyl ether was 88% at a reaction temperature of 350° C. The resulting reformed gas had a slight methanol content. However, the yield of carbon monoxide (CO) with carbon as reference [produced amount of CO/(CO+CO₂+CH₄+CH₃OH)] was as high as 74%.

The produced amount of hydrogen may be raised by converting carbon monoxide to carbon dioxide, e.g., by water-gas shift reaction (CO shift reaction) according to the reaction represented by the following formula (3), in the presence of a mixture of the reforming catalyst with a CO shift catalyst.
CO+H₂O→H₂+CO₂ (3)

Two kinds of CO shift catalyst were examined and will be described below by way of a non-limiting example. One of the two CO shift catalysts was a copper-zinc-almina (Cu—ZnO—Al₂O₃) shift catalyst made of 30% by weight Cu/ZnO/Al₂O₃. The other CO shift catalyst (Pt/Al₂O₃-based) was a Pt-containing solid base catalyst having 1% by weight of platinum (Pt) supported on alumina having cesium (Ce) and rhenium (Re) supported thereon. The results of the steam reforming experiment on dimethyl ether in the presence of catalyst mixtures were obtained by mixing the two CO shift catalysts with the equal part of the aforementioned reforming catalyst (e.g., 1 g of CO shift catalyst+1 g of reforming catalyst), respectively.

Catalysts having a size of from 20 to 40 mesh were uniformly mixed. The molar ratio of dimethyl ether (DME) to water in the mixture of dimethyl ether and water was 1:4, the amount of the catalyst mixture was (1+1) g and the contact time (W/F) was about (3+3) g−cat·hr/mol.

The percent conversion of dimethyl ether was about 100% both for the mixture of the reforming catalyst and the Cu—ZnO—Al₂O₃ CO shift catalyst and the mixture of the reforming catalyst and the Pt/Al₂O₃-based CO shift catalyst. The yield of carbon monoxide (CO) with carbon as reference was 21% for the mixture of the reforming catalyst and the Cu—ZnO—Al₂O₃ CO shift catalyst; and 6% for the mixture of the reforming catalyst and the Pt/Al₂O₃-based CO shift catalyst. Thus, the percent conversion of dimethyl ether can be enhanced and the yield of carbon monoxide can be reduced as compared with the case where reforming is conducted in the presence of the reforming catalyst alone.

However, when the mixture of the reforming catalyst and the Cu—ZnO—Al₂O₃ CO shift catalyst was used, the percent conversion of dimethyl ether was almost 100% in the initial stage of reaction but gradually decreased with time.

In order to study the cause of this phenomenon, an additional experiment was made on the two CO shift catalysts by way of example. Carbon monoxide was allowed to undergo a shift reaction at various temperatures in the presence of the Cu—ZnO—Al₂O₃ CO shift catalyst and Pt/Al₂O₃-based CO shift catalyst. The concentration of carbon monoxide in the initial stage of reaction was 5.5% and the contact time (W/F) was about 1.5 g−cat·hr/mol.

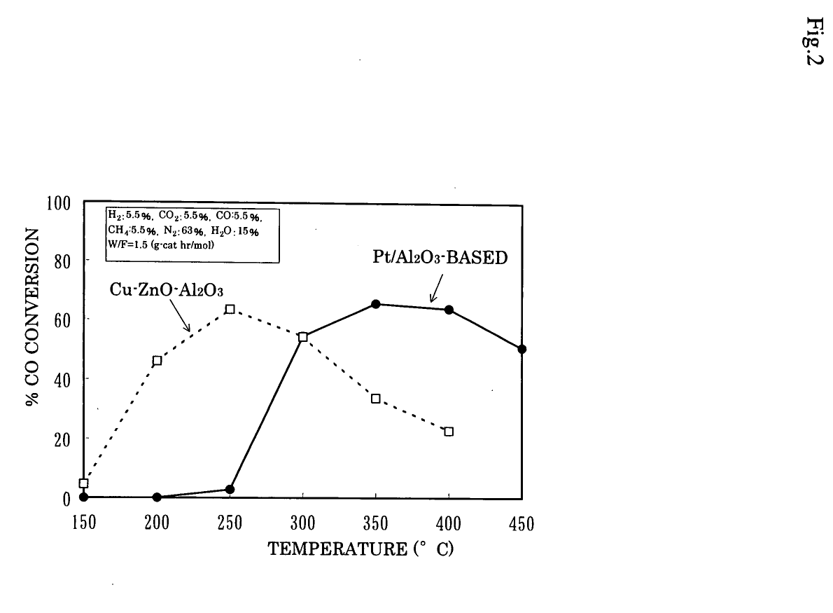

The results of the experiment are shown in FIG. 2. In the presence of the Cu—ZnO—Al₂O₃ CO shift catalyst, the percent conversion increased with temperature up to 250° C. but began to drop when the temperature exceeded 250° C. On the other hand, in the presence of the Pt/Al₂O₃-based CO shift catalyst, the reaction began to occur at a temperature of about 200° C. and reached almost maximum at 350° C. The drop of the percent conversion by the Cu—ZnO—Al₂O₃ CO shift catalyst was attributed to the gradual sintering of Cu in the Cu—ZnO—Al₂O₃ CO shift catalyst with time. When using a mixture of the catalyst having the noble metal used in the reforming portion supported thereon, the reforming catalyst of γ-alumina having platinum supported thereon and the Pt/Al₂O₃-based CO shift catalyst, the reaction was executed in the reforming portion at a temperature of from 300° C. to 400° C.

Even when alumina having any one of potassium (K), magnesium (Mg), calcium (Ca) and lanthanum (La) supported thereon was used as solid base instead of alumina having cesium (Ce) and rhenium (Re) supported thereon, similar effects were exerted. Also, even when any of palladium (Pd) and ruthenium (Ru) was used instead of platinum, similar effects were exerted. Accordingly, alumina having at least one element selected from the group consisting of potassium (K), magnesium (Mg) , calcium (Ca), lanthanum (La), cesium (Ce) and rhenium (Re) supported thereon are examples that may be used as solid base; and alumina having at least one noble metal selected from the group consisting of platinum (Pt), palladium (Pd) and ruthenium (Ru) are examples that may be used as second noble metal.

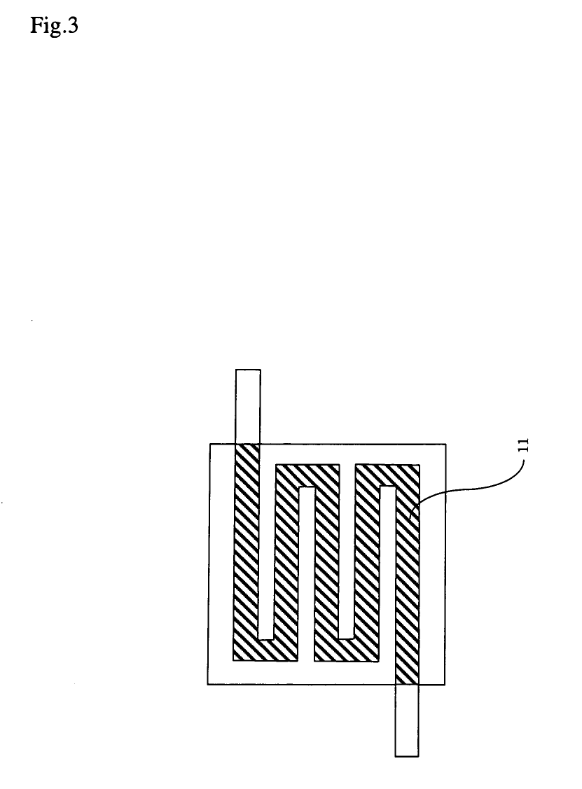

Non-limiting modifications of the layout the reforming catalyst and the CO shift catalyst in a channel of the reforming portion 3 will be described hereinafter in connection with FIGS. 3 to 5.

FIG. 3 illustrates the aforementioned non-limiting example wherein the mixture 11 of reforming catalyst and CO shift catalyst is uniformly provided on an inner wall surface within the channel.

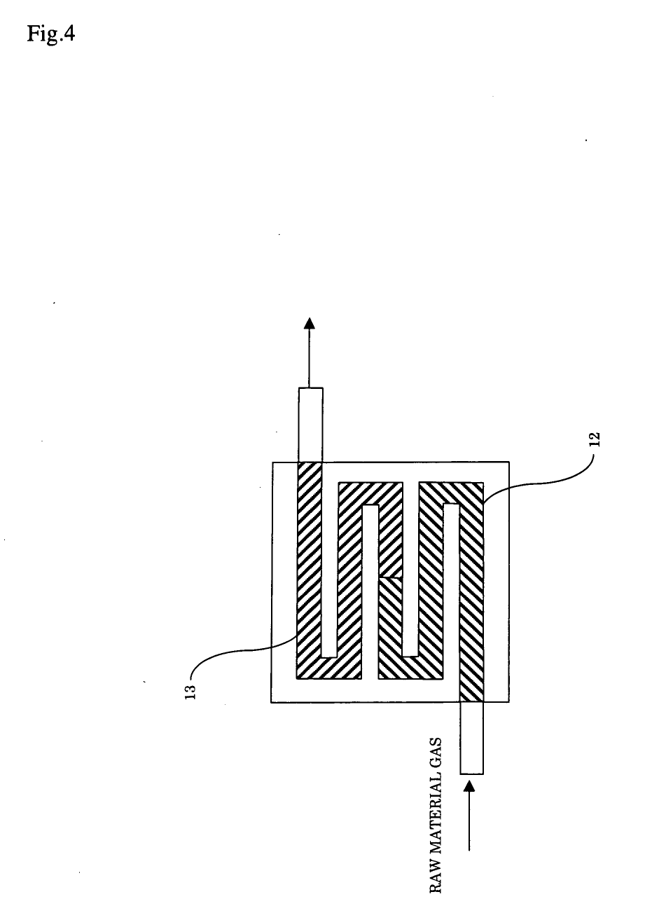

FIG. 4 illustrates another non-limiting example wherein, as a mixture of reforming catalyst and CO shift catalyst, the channel includes a mixture 12 (content of reforming catalyst is greater than that of CO shift catalyst) having a higher proportion of reforming catalyst toward the vaporizing portion 2 (upstream in the direction of passage of fuel) and a mixture 13 (content of CO shift catalyst is greater than that of reforming catalyst) having a higher proportion of CO shift catalyst toward the CO selective oxidizing portion 4 (downstream in the direction of passage of fuel).

Toward the vaporizing portion 2 in the channel, the concentration of vaporized ether rises. Toward the CO selective oxidizing portion 4 in the channel, the concentration of hydrogen produced by reforming and carbon monoxide which is a by-product rises. Accordingly, when the mixture 12 (content of reforming catalyst is greater than that of CO shift catalyst) is provided toward the vaporizing portion 2 in the channel and the mixture 13 (content of CO shift catalyst is greater than that of reforming catalyst) is provided toward the CO selective oxidizing portion 4 in the channel, e.g., according to the distribution of above-noted ether and hydrogen concentrations, the reforming and CO shifting efficiency can be raised.

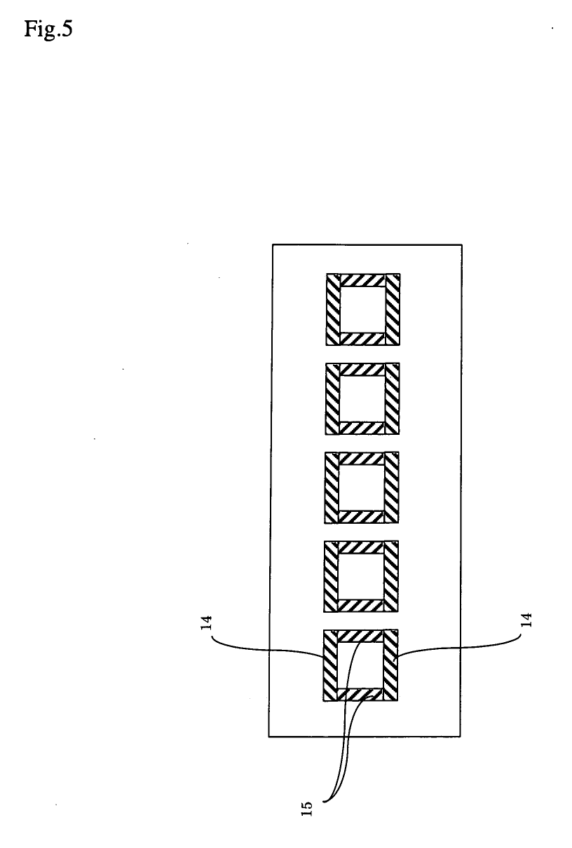

FIG. 5 is a sectional view of the reforming portion 3 illustrating another non-limiting example wherein the channel has differentiated surfaces, e.g., inner wall surfaces or other surfaces contacting the vaporized fuel, at least one of which may have a reforming catalyst 14 provided thereon and another of which may have a CO shift catalyst 15 provided thereon.

Grooves may be formed on the channel surfaces, e.g., by precision machining using an NC machine tool, to support the respective catalyst. The differentiated surfaces may form interior surfaces of prefabricated portions of the channel joined, e.g., using tabular members or other fasteners, to construct the channel or another conduit.

In this example, as shown in FIG. 5, the differentiated are inner wall surfaces forming part of four planar portions, which are coupled via tabular members are to form a channel having a rectangular cross-section. Two of the inner wall surfaces within the channel may have a reforming catalyst provided thereon and the other two may have a CO shift catalyst provided thereon. The vaporized fuel can come in contact with the reforming catalyst while carbon monoxide can come in contact with the CO shift catalyst, thereby providing a similar effect as in the example shown in FIG. 3 without previously mixing the catalysts.

The CO selective oxidizing portion 4 will be further described hereinafter. Inside the CO selective oxidizing portion 4 may be provided a channel, e.g., serpentine or parallel channel, through which the reformed gas flows. On a surface within the channel, e.g., inner wall surface or other surface contacting the reformed gas, is provided a CO selective oxidizing catalyst, e.g., alumina having a noble metal such as ruthenium (Ru) supported thereon. The use of a noble metal prevents oxidization and corrosion of the CO selective oxidizing catalyst, without using incidental facilities for preventing the oxidation and corrosion of the catalyst during the suspension of operation of the fuel cell.

The fuel cell stack 5 will be further described hereinafter. The fuel cell stack 5 may comprise an electrolyte membrane 18 having protonic conductivity, e.g., a membrane made of a fluorocarbon polymer having a cationic exchange group such as sulfonic acid group and carboxylic acid group such as Nafion (trade name, produced by Du Pont Inc.). The electrolyte membrane 18 may be provided interposed between a fuel electrode 16 (anode) and an oxidizing agent electrode 17 (cathode). Both the fuel electrode 16 and oxidizing agent electrode 17 may be made of a porous sheet, e.g., a sheet comprising a carbon black powder-supported platinum retained by a water-repellent resin binder such as polyethylene tetrafluoride (PTFE). The porous sheet may also comprise a sulfonic acid-based perfluorocarbon polymer or a particulate material coated by the polymer incorporated therein.

The hydrogen which has been supplied into the fuel electrode 16 is reacted at the fuel electrode 16, according to the following formula (4):
H₂→2H⁺+2e⁻ (4)

The hydrogen is separated into hydrogen ions (protons) and electrons. On the other hand, the oxygen supplied into the oxidizing agent electrode 17 is reacted at the oxidizing agent electrode 17, e.g., according to the following formula (5):
½O₂+2H⁺+2e⁻→H₂O (5)

The water is produced, and electricity is generated. The combusting portion 7 will be further described hereinafter.

Inside the combusting portion 7 is provided a channel, e.g., serpentine or parallel channel, through which the reformed gas used in generation of electricity flows. On the a surface within the channel, e.g., inner wall surface or other surface contacting the reformed gas, is provided a combustion catalyst, e.g., alumina having a noble metal such as platinum (Pt) and/or palladium (Pd) supported thereon. The use of a noble metal as combustion catalyst prevents the oxidation and deterioration of the combustion catalyst, without using incidental facilities for preventing the oxidation and deterioration of the catalyst during the suspension of operation of the fuel cell.

Thus, since the fuel cell according to the first non-limiting embodiment of the invention comprises catalysts containing a noble metal, e.g., the catalysts for use in the reforming portion 3, the CO selective oxidizing portion 4 and the combusting portion 7, the oxidation and deterioration of those catalysts can be prevented, without using incidental facilities for preventing the oxidation and deterioration of the catalyst during the suspension of operation of the fuel cell. Accordingly, the size of the fuel cell can be reduced.

Further, the first embodiment provides a higher percent conversion of ether to hydrogen than would be achieved in the presence of the first catalyst alone. The first embodiment also allows the shift reaction of carbon monoxide to hydrogen (in the presence of the second catalyst) to occur at a high percent conversion within a reforming temperature range. In other words, even when both the first and second catalysts are provided in the reforming portion 3, a high percent conversion can be realized both for the reforming reaction of dimethyl ether to hydrogen and the shift reaction of carbon monoxide to hydrogen. In addition, since the reforming portion is used to effect the reforming and CO shifting reactions, the components for controlling the temperature of the CO shift portion, e.g., sensors, can be eliminated.

### Second Embodiment

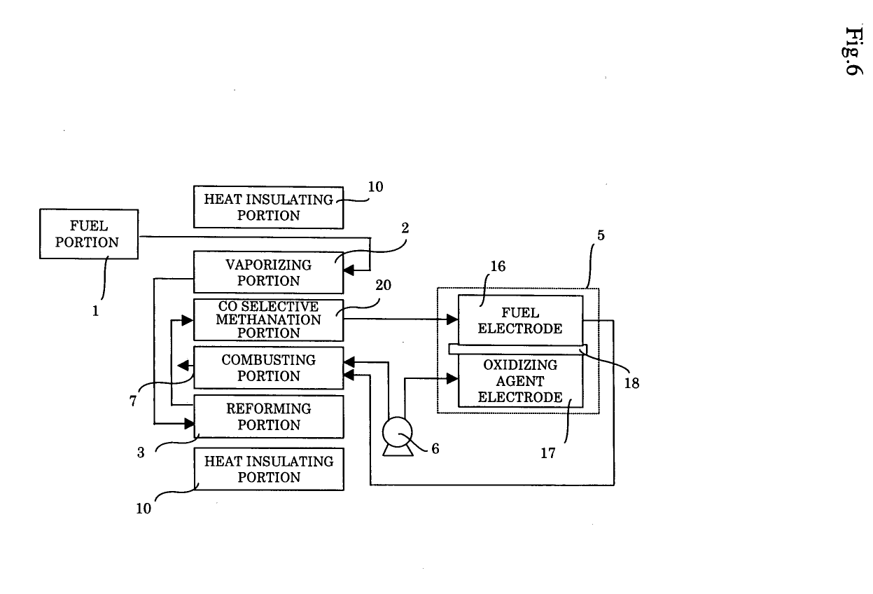

FIG. 6 illustrates an example of a fuel cell according to a second non-limiting embodiment of the invention.

A CO selective methanation portion 20 (CO removing portion) is provided instead of the CO selective oxidizing portion 4. The CO selective methanation portion 20 is connected to the reforming portion 3 and the fuel cell stack 5.

The gas which has been reformed in the reforming portion 3 and passed to the CO selective methanation portion 20 contains carbon dioxide or carbon monoxide as a by-product besides hydrogen. Carbon monoxide deteriorates the anode catalyst of a fuel cell unit, causing the deterioration of electricity-generating properties of the fuel cell unit. Therefore, in this non-limiting embodiment, carbon monoxide is methanated at the CO selective methanation portion 20, e.g., according to the formula (6). Accordingly, carbon monoxide may be removed to a concentration of less than 10 ppm before the gas containing hydrogen is supplied from the reforming portion 3 into the fuel cell stack 5.
CO+3H₂→CH₄+H₂O (6)

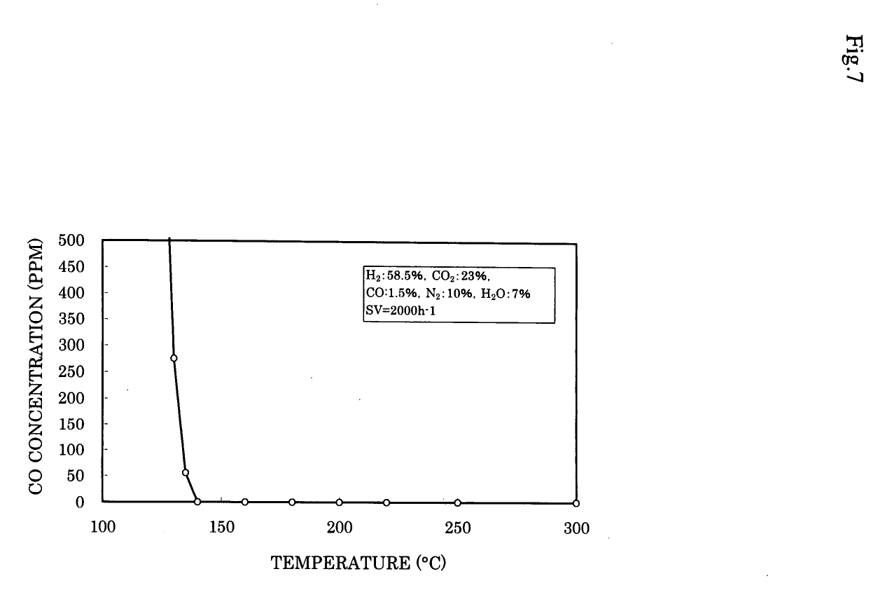

Inside the CO selective methanation portion 20 is provided a CO selective methanation catalyst. FIG. 7 illustrates, by way of example, temperature characteristics of a CO selective methanation catalyst, e.g., methanation catalyst containing ruthenium (Ru), on the removal of carbon monoxide. The methanation of carbon monoxide, in the presence of a CO selective methanation catalyst containing ruthenium (Ru), increases as the temperature rises. The gas thus obtained by methanation has a reduced concentration of carbon monoxide.

Within the methanation temperature range of higher than 140° C., much of the carbon monoxide is methanated. The gas thus obtained by methanation can have a carbon monoxide content of less than 10 ppm, even when the heating temperature of the CO selective methanation portion 20 is lower than the inner temperature of the reforming portion 3. Thus, the CO selective methanation portion 20, which may be provided adjacent to the combusting portion 7 as in the case of the CO selective oxidizing portion 4, can be heated by combustion heat having a temperature similar to the combustion heat provided to the reforming portion 3.

Further, since the fuel cell according to the second non-limiting embodiment comprises the CO selective methanation portion 20 instead of the CO selective oxidizing portion 4, the oxygen for oxidizing carbon monoxide to carbon dioxide can be eliminated. Thus, the capacity of the air pump 6 and size of the fuel cell can be reduced.

### Third Embodiment

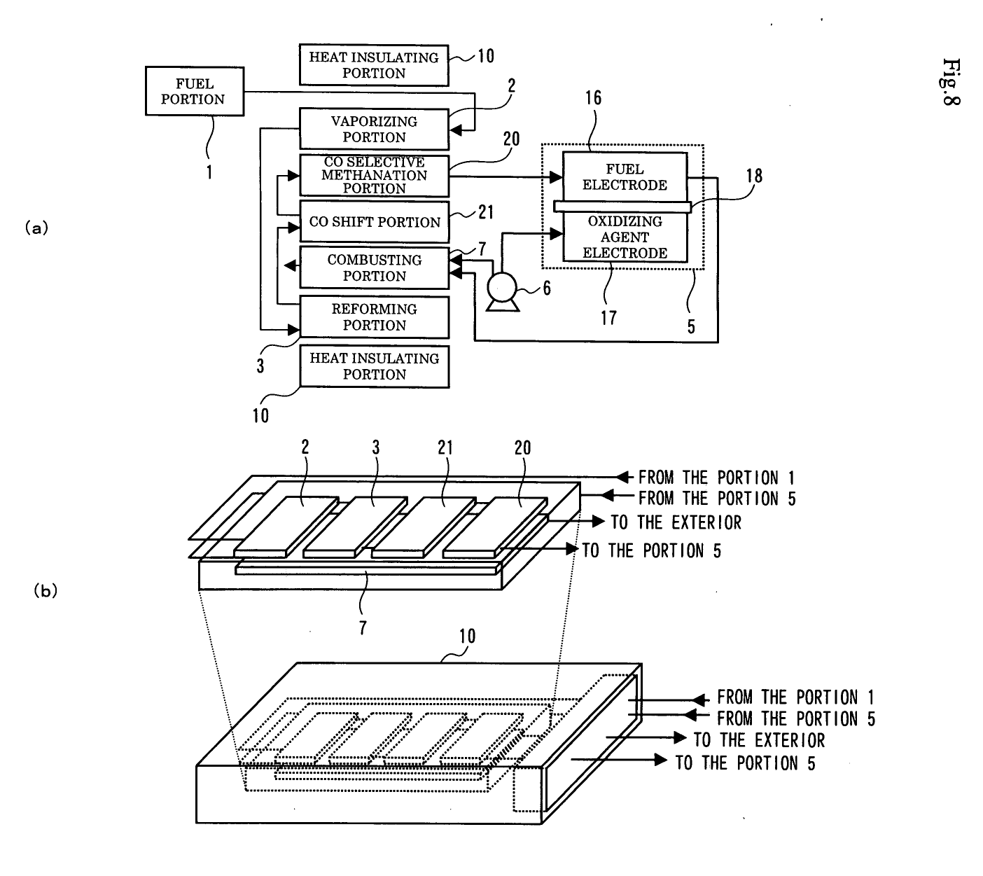

FIG. 8 illustrates an example of a fuel cell according to a third non-limiting embodiment of the invention.

As shown, a CO shift portion 21 may be provided interposed between the reforming portion 3 and the CO selective methanation portion 20. Inside the CO shift portion 21 is provided a third catalyst. As the third catalyst, by way of example, there may be used a catalyst comprising at least one noble metal (e.g., platinum (Pt), palladium (Pd) and ruthenium (Ru)) supported on alumina, with the alumina having at least one element selected from the group consisting of potassium (K), magnesium (Mg), calcium (Ca), lanthanum (La), cesium (Ce) and rhenium (Re) supported thereon.

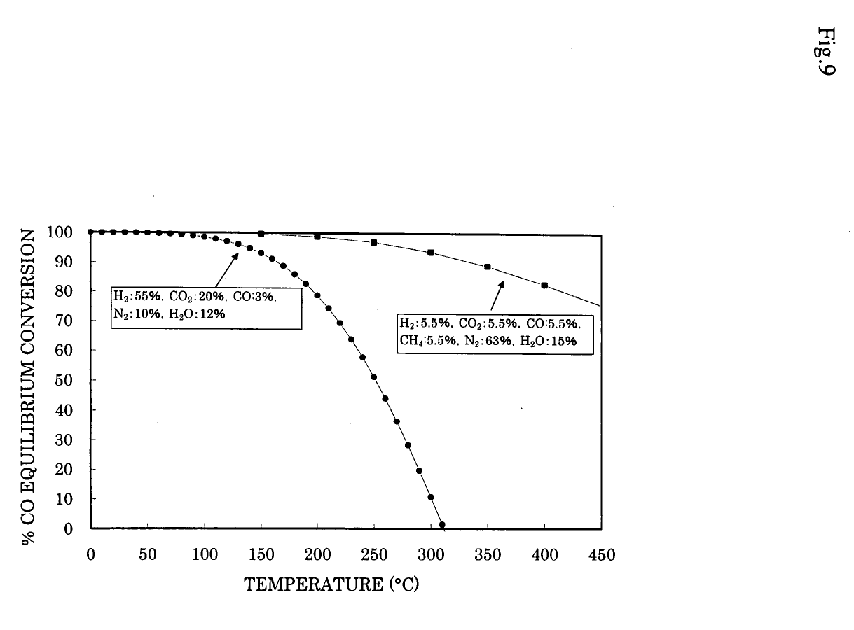

The gas which has been reformed in the reforming portion 3 and passed to the CO shift portion 21 may contain carbon monoxide, though in a reduced amount as compared with conventional fuel cells. Referring to the second catalyst, the percent equilibrium conversion of carbon monoxide drops as the temperature increases as shown in FIG. 9. On the other hand, as shown in FIG. 2, for the second catalyst, the percent conversion of carbon monoxide drops as the temperature decreases.

Therefore, carbon monoxide may be subjected to conversion at a high temperature in the reforming portion 3 where the concentration of carbon monoxide is high. Thereafter, the reformed gas having somewhat reduced concentration of carbon monoxide may again be subjected to conversion of carbon monoxide at a temperature of lower than the inner temperature of the reforming portion 3. The temperature of reaction in the CO shift portion 21 may therefore be lower than the temperature of the reforming portion 3, e.g., lower than 300° C., and higher than the temperature at which conversion is initiated as shown in FIG. 2, e.g., higher than 200° C.

Thus, the CO shift portion 21 according to the third embodiment can generate additional hydrogen. In this arrangement, a fuel cell having a higher electricity-generating efficiency can be provided.

While the invention has been described in detail and with reference to specific embodiments thereof, it will be apparent to one skilled in the art that various changes and modifications can be made therein without departing from the spirit and scope thereof.

1. A fuel cell system comprising:
a fuel supplying unit configured to supply a fuel containing at least dimethyl ether;
a reforming portion including a conduit provided through which the fuel supplied by the fuel supplying unit can be passed;
a first catalyst provided on a first surface within the conduit and configured to accelerate a reforming reaction by which the fuel is reformed to a gas containing hydrogen, the first catalyst including a solid acid and a first noble metal;
a second catalyst provided on the first surface or a second surface within the conduit and configured to accelerate a shift reaction by which carbon monoxide and water produced during the reforming reaction are converted to hydrogen and carbon dioxide, the second catalyst including a solid base and second noble metal;
a CO removing portion configured to remove carbon monoxide left unreacted after the shift reaction; and
a fuel cell unit configured to generate electricity from oxygen and the hydrogen produced by the reforming reaction and shift reaction.

2. A fuel cell system of claim 1, wherein the shape of a cross-section of the conduit is rectangular, and the first catalyst and the second catalyst are provided on the first and second surfaces within the conduit, respectively.

3. A fuel cell system of claim 1, wherein the first catalyst and the second catalyst are provided in an admixture on the first surface within the conduit.

4. A fuel cell system of claim 3, wherein the proportion of the first catalyst is higher than that of the second catalyst at an upstream side of the conduit in a direction of passage of the fuel through the conduit and the proportion of the second catalyst is higher than that of the first catalyst at a downstream side of the conduit.

5. A fuel cell system of claim 1, wherein the first noble metal contains at least one element selected from the group consisting of platinum (Pt), palladium (Pd) and rhodium (Rh).

6. A fuel cell system of claim 5, wherein the weight of the first noble metal is from 0.25% by weight to 1.0% by weight based on the weight of the first catalyst.

7. A fuel cell system of claim 1, wherein the solid acid is γ-alumina.

8. A fuel cell system of claim 1, wherein the second noble metal contains at least one element selected from the group consisting of platinum (Pt), palladium (Pd) and ruthenium (Ru).

9. A fuel cell system of claim 1, wherein the solid base is alumina having at least one element selected from the group consisting of potassium (K), magnesium (Mg), calcium (Ca), lanthanum (La), cesium (Ce) and rhenium (Re) supported on the alumina.

10. A fuel cell system of claim 1, wherein the temperature of the reforming reaction and shift reaction in the reforming portion is from 300° C. to 400° C.

11. A fuel cell system of claim 1, wherein the fuel further contains water and methanol.

12. A fuel cell system of claim 1, wherein the fuel supplying unit supplies the fuel via pressure exerted by the dimethyl ether.

13. A fuel cell system of claim 1, further comprising a combusting portion for combusting hydrogen contained in gas discharged from the fuel cell unit.

14. A fuel cell system of claim 13, further comprising a heat insulating portion covering the periphery of at least one of the reforming portion, the CO removing portion and the combusting portion.

15. A fuel cell system of claim 1, further comprising a catalyst containing ruthenium (Ru) and accelerating the methanation of carbon monoxide in the CO removing portion.

16. A fuel cell system of claim 15, wherein the temperature of the methanation reaction in the CO removing portion is from 140° C. to lower than a temperature of an interior of the reforming portion.

17. A fuel cell system of claim 1, further comprising a CO shifting portion including a third catalyst to accelerate the shift reaction by which carbon monoxide and water are converted to carbon dioxide and hydrogen.

18. A fuel cell system of claim 17, wherein the CO shifting portion is provided interposed between the reforming portion and the CO removing portion.

19. A fuel cell system of claim 17, wherein the third catalyst comprises:
a carrier including alumina comprising at least one element selected from the group consisting of potassium (K), magnesium (Mg), calcium (Ca), lanthanum (La), cesium (Ce) and rhenium (Re) supported on the alumina; and
a noble metal containing at least one element selected from the group consisting of platinum (Pt), palladium (Pd) and ruthenium (Ru).

20. A fuel cell system of claim 19, wherein the temperature of the shift reaction in the CO shifting portion is from 200° C. to 300° C.
